(19) United States
(12) Patent Application Publication
(10) Pub. No.: US 2007/0130529 A1
(43) Pub. Date: Jun. 7, 2007

(54) Automatic generation of user interface descriptions through sketching

(76) Inventor: Paul Shrubsole, Arnhem (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,575

(22) PCT Filed: Oct. 12, 2004
(86) PCT No.: PCT/IB04/52069

§ 371 Date: Apr. 11, 2006

Related U.S. Application Data
(60) Provisional application No. 60/511,352, filed on Oct. 15, 2003.

(51) Int. Cl. G06F 3/00; G06F 17/00

(52) U.S. Cl. 715/762; 715/700; 715/513

(57) ABSTRACT

A desired graphic user interface (GUI) is sketched and then scanned into memory or is sketched using a stylus whose movements are tracked and recorded in memory. Sketched objects such as windows, lists, buttons and frames are recognized automatically and normalized for the GUI to be created. Containment relations among the objects are recorded in a tree hierarchy to which is attached layout information and information from annotations in the sketch. The tree hierarchy is then formatted for generation of the GUI on a target platform.

The present invention relates to graphic user interfaces (GUIs), and particularly to generating descriptions of GUIs.

Graphic user interfaces (GUIs) are typically created by computer programmers who write software routines that work with the particular windowing system to generate the GUI. A GUI is a computer program or environment that displays symbols on-screen that may be selected by the user via an input device so as to generate user commands.

Besides the difficulty of writing and of modifying the software routines, they are usually tailored to the particular windowing system and, to that extent, lack portability.

Some drawing programs are used for GUI generation. Drawing programs are applications used to create and manipulate images and shapes as independent objects, i.e. vector images, rather than bitmap images. Use of vector images instead of bitmap images eases editing and saves storage.

U.S. Pat. No. 6,246,403 to Tomm, the entire disclosure of which is hereby incorporated herein by reference, notes the above disadvantages of standard GUI generation, and further notes that existing drawing programs, although they enable non-programmers to create a GUI, normally cannot modify the GUI and are likewise tailored only to a particular windowing system.

The Tomm methodology uses a text editor to create bitmap images in a “text file.” The text file contains, instead of commands, pictorial information that resembles the GUI desired. Elements (such as windows, buttons, lists) of the GUI are portrayed on-screen by the user by navigating around the screen and placing a particular character repeatedly to delimit the GUI elements. The user optionally annotates each element with a name such as “Press Me” that will be displayed in the GUI inside the element, and with a data type to describe functionality, e.g., “button” indicating that the particular element is a button. A data tree structure which defines which elements on-screen are contained within which other elements also includes layout of the elements, as well as the data types and names associated with elements. In this format, the GUI description can easily be conveyed to an application program interface (API) particular to a target platform for the GUI.

However, repeated entering of delimiters to define the interface can be tedious for the user. For example, Tomm demonstrates the use of hyphens, plus signs and vertical bars to design the interface, which involves considerable effort. Also, the keyboard required is not always conveniently available, particularly for mobile devices such as personal digital assistants (PDAs), mobile phones and hybrid portable units.

U.S. Pat. No. 6,054,990 to Tran, the disclosure of which is hereby incorporated herein by reference in its entirety, relates to vectorizing a sketch and comparing the series of vectors to one or more reference objects to determine the best matching object(s), e.g. a triangle.

A need exists for GUI generating that is easy and convenient for the non-programming user and that is easily transportable to a selected platform.

The present invention is directed to overcome the above-noted deficiencies in the prior art.

According to the present invention, a user may sketch a desired GUI using a pen and digitizer, or alternatively on an optically-scannable medium to be scanned. In an automatic phase, unsteadily drawn straight lines are recognized and straightened and lines are made parallel to other lines, as appropriate, to resemble pre-stored reference objects. Automatically, it is determined which objects are contained on-screen within which other objects. A user interface description is generated that reflects this data, as well as layout information including functional description of the objects and overlay priority among objects in the GUI to be created.

In particular, a user interface description generating method in accordance with the present invention includes the step of manually sketching objects to create a sketch representative of a GUI to be created, and automatically performing subsequent functions to create the user interface description. Specifically, the sketch is examined to identify sketched versions of the object, which are then conformed to resemble respective reference images. From the conformed versions, a determination is made of a hierarchy of relative containment among the conformed versions. Finally, from the hierarchy a user interface description is generated for creating the GUI.

Details of the invention disclosed herein shall be described with the aid of the figures listed below, wherein like features are numbered identically throughout the several views:

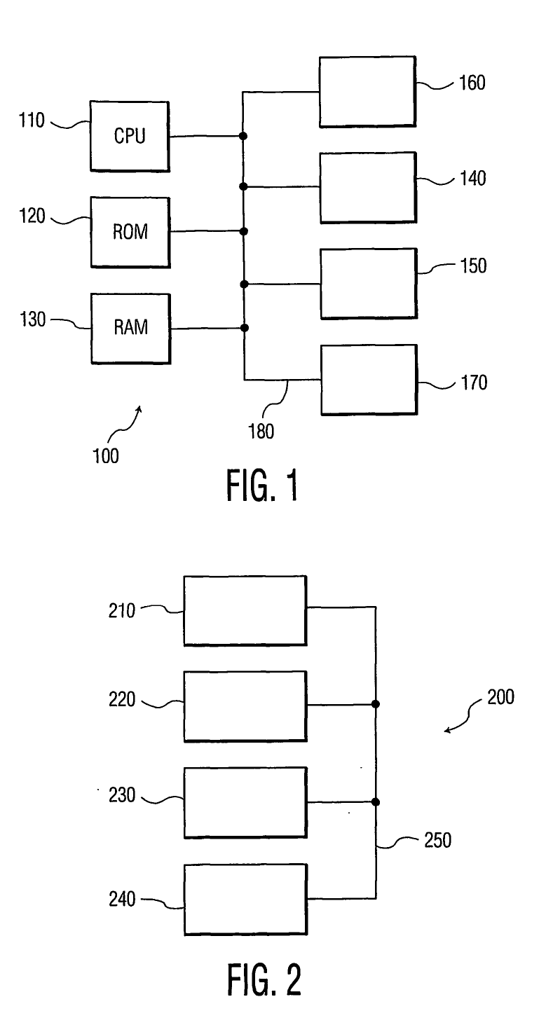

FIG. 1 is a block diagram of a user interface description generating apparatus according to the present invention;

FIG. 2 is block diagram of a program according to the present invention;

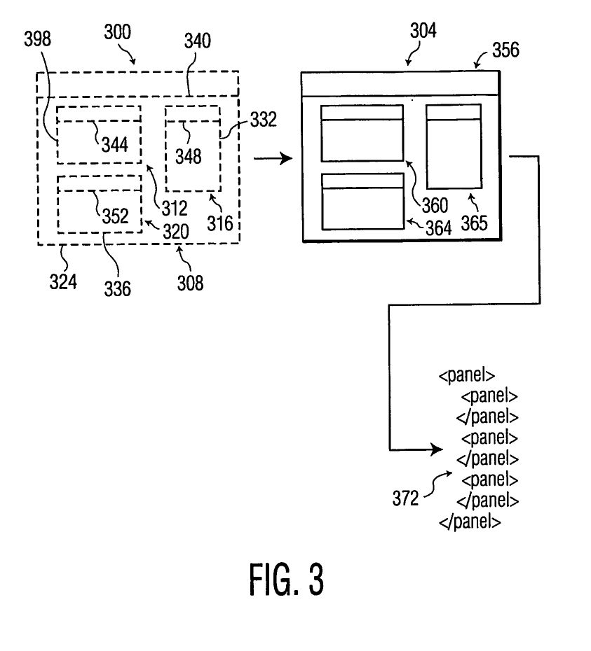

FIG. 3 is a conceptual diagram of the conforming of a sketch and of the conversion of the sketch into a user interface description according to the present invention;

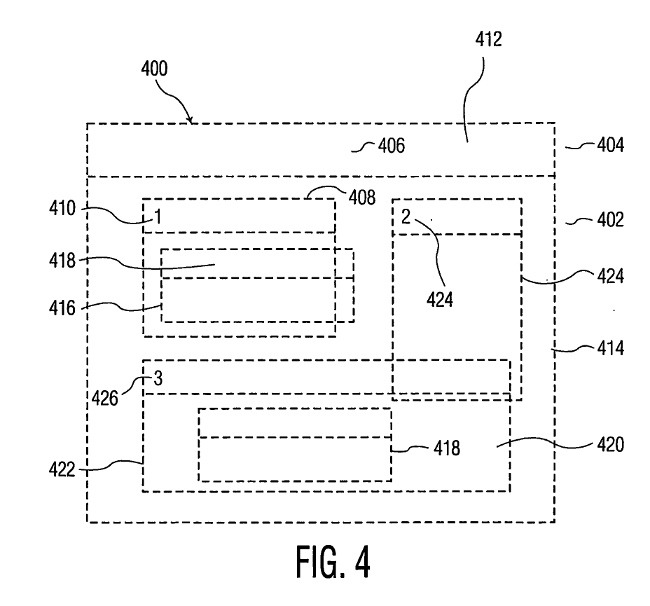

FIG. 4 is a depiction of a sketch of a GUI according to the present invention;

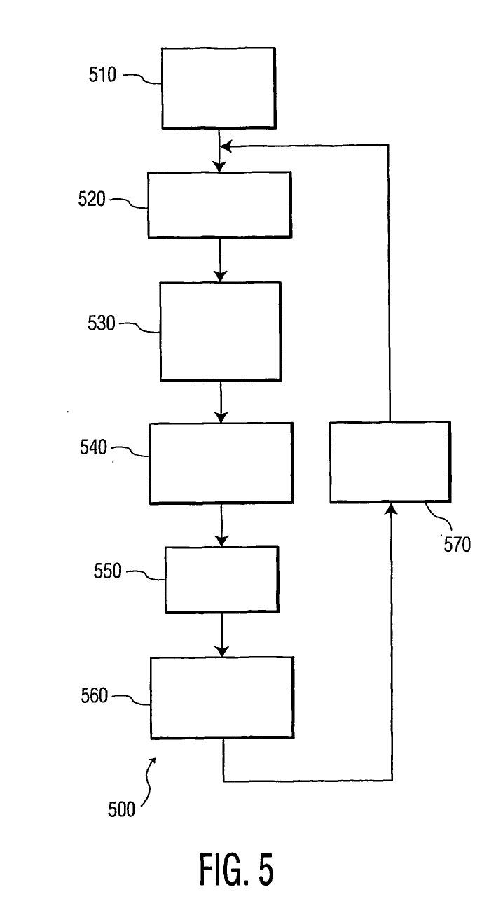

FIG. 5 is a flow diagram illustrating operation of the present invention in conjunction with a scanner and optical character recognition (OCR); and

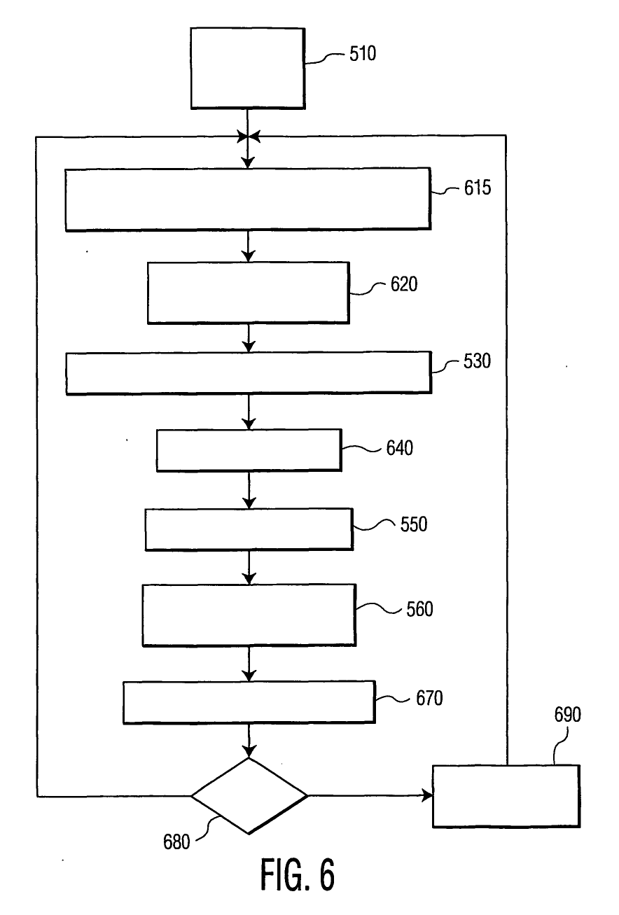

FIG. 6 is a flow diagram illustrating operation of the present invention in conjunction with a pen/digitizing unit and sketch editor.

FIG. 1 illustrates, by way of non-limitative example, a user interface description generating apparatus 100 according to the present invention. The apparatus 100 includes a central processing unit (CPU) 110, a read-only memory (ROM) 120, a random access memory (RAM) 130, a pen/digitizer unit 140 and a liquid crystal display (LCD) 150 as described in U.S. Pat. No. 6,054,990 to Tran. Also featured in the apparatus 100 are a scanner 160, a sketch editor 170 and a data and control bus 180 connecting all of the above components.

The computer program 200 in ROM 120, as illustratively portrayed in FIG. 2, includes a sketch identifier 210, a sketch normalizer 220, a hierarchy determiner 230 and a description generator 240. Each of these modules of program 200 is communicatively linked to the others as appropriate, as conceptually represented in FIG. 2 by a link 250. Alternatively, these modules and the ROM 120 may be implemented, for example, in hardware as a dedicated processor.

As shown in FIG. 3, a sketch 300 is conformed to produce a normalized sketch 304 in an electronic storage medium, here RAM 130. The sketch 300 may have been scanned into memory using the scanner 160, or may, during sketching, have been recorded into memory in real time by means of the pen/digitizer unit 140.

The sketch 300 is made up of four sketched versions of objects, versions 308 through 320. Each of the versions 308-320 is delimited by a respective one of the outlines 324-336 and contains a respective one of the dividing lines 340-352. In this example, each of the objects or widgets represents a tab panel, which is a section of an integrated circuit (IC) designer menu that can be selected to display a related set of options and controls.

Conforming the sketch causes each side of the outlines 324-336 to be straightened to resemble a corresponding reference object, such as a vector image. The associated reference object may be a vertical or horizontal straight line or may be a rectangle such as any of the reference objects 356-368. The reference objects 356-368 are stored in ROM 120 or RAM 130 and may similar (proportional in dimension) to the normalized objects rather than identical to them. The conforming also makes opposites sides in the outlines 324-336 parallel. The dividing lines 340-352 are likewise straightened and made parallel to respective outline sides. If, however, the reference vector image has non-straight or non-parallel lines, such as in the case of a circle, the conforming makes the sketched version resemble the reference object without straightening lines or making them parallel as appropriate. The process of matching the sketch to one or more reference objects is described in Tran.

As FIG. 3 further shows, the normalized sketch is used to generate a tree hierarchy 372 defining containment among the objects. The sketch was originally scanned in or recorded as a bit map image. Although the conforming or normalizing has modified the sketch to conform to a one or more reference objects, which may be vector images, the conformed sketch preferably remains in bit map form. Since U.S. Pat. No. 6,246,403 to Tomm forms a tree representation of containment among bit map images, this technique may be applied to the normalized sketch. Here, the tree hierarchy 372 is implemented in a hierarchical, structured mark-up language such as XML. An application program interface (API) for a target platform for the GUI may easily be programmed.

FIG. 4 illustrates annotation of sketched objects and the overlapping of objects in a sketch 400 in accordance with the present invention. A sketched version 402 has a dividing line 404 and optionally a data type 406 of “panel” which may indicate that the corresponding object is a tab panel as discussed in connection with FIG. 3. Referring again to FIG. 4, a sketched version 408 is annotated with an indicia 410 of stacking order or “z-order,” in this instance the number “1.” The number “1” therefore represents a priority of the object corresponding to this sketched version with respect to objects of other sketched versions annotated with a respective priority. Specifically, if an object of stacking order 2 or greater intersects the panel 406 object, either in the sketch or at any future time, e.g. through movement of windows in the GUI to be created, panel 406 has priority to overlay the lower priority window. The higher priority panel 406 thus hides the overlaid window to the extent of the overlaying or intersecting respective portions of the two objects. The dividing line 404 divides the sketched object 402 into a labeling area 412 and a contents area 414, the labeling area being smaller than the contents area. The word “panel” is recognized as a data type, by virtue of the word “panel” being located within the labeling area 412 rather than in the contents area 414. The same applies to indicia of priority which are recognized as such if located within a labeling area. By contrast, Tomm describes a more difficult annotating process where repeated characters for delimiting boxes are interrupted to introduce the annotation on the box border.

A sketched version 416 having the data type 418 of “button” intersects the panel 406 but lacks an indicia of stacking order. Since the version 416 is within the contents area of version 408, the version 416 is recognized as contained within the version 408 so that the object corresponding to version 416 is contained on-screen within the object corresponding to version 408 in the GUI to be created. By the same token, all of the objects corresponding to the sketched versions shown within sketched version 402 will be contained on-screen within panel 406 in the GUI to be created. In an alternative embodiment, containment of intersecting versions is resolved based on data type if one or both versions lack indicia of priority, e.g. a “button” can be required to be contained within any other data type.

As further shown in FIG. 4, a button version 418 is contained within a contents area 420 of a frame version 422, and so the button if framed in the GUI to be created. A “list” version indicates a list that has priority to overlay the object corresponding to the frame version 422, due to their relative indicia of priority 424, 426.

These rules are merely exemplary and do not limit the intended scope of the invention.

FIG. 5 illustrates, in an embodiment 500 of the present invention, operation in conjunction with a scanner and optical character recognition (OCR). The reference objects are pre-stored in electronic storage, ROM 120 or RAM 130 (step 510). The scanner 160 scans the sketch into RAM 130 (step 520). The sketch identifier 210 identifies sketched versions of the objects by, for example, determining a best match between a series of reference vectors pre-stored and the sketch or a portion of the sketch (step 530). The identified sketched versions are conformed by the sketch normalizer 220 to the reference objects to normalize the sketch, and annotating data types and priority indicia are recognized through optical character recognition (OCR) (step 540). The hierarchy determiner 230 then determines the hierarchy of on-screen containment among the conformed versions of objects in the GUI to be created. Data type, priority and other annotations, as well as screen coordinates defining layout as detailed in Tomm, are included in the generated tree hierarchy (step 550). The description generator 240 generates the user interface description in form usable by an API in creating the GUI on a target platform (step 560). The sketch can then be edited, or a new sketch created (step 570), for scanning in step 520.

FIG. 6 illustrates operation of the present invention in conjunction with a pen/digitizing unit and sketch editor, identical steps from FIG. 5 retaining their reference numbers. The user sketches by manipulating a pen, which can be, for example, a light pen or a pen whose movement is sensed by an electromagnetic field as in Tran. The digitizer of the pen/digitizer 140 records respective screen coordinates tracked by movement of the pen, which may constitute a new sketch or augmentation of a previously processed sketch that is being modified (step 615). The recording occurs in real time (step 620). The sketched versions are then, as described above, identified (step 530) and normalized (step 640), with the hierarchy being determined and the user interface description being generated as also described above (steps 550-560). The sketch is stored in RAM 130 (step 670), and a new sketch can be prepared for processing (step 680, NO branch). Otherwise, if the sketch is to be subsequently edited (step 680), it may be displayed on the LCD 150 to aid the user in augmenting the sketch (step 690). Alternatively, if the editing involves deleting, changing or moving objects in the sketch, the pen may be provided with buttons or other input devices may be implemented to operate menus in a known manner to edit graphic objects interactively on-screen.

While there have been shown and described what are considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A user interface description generating apparatus comprising:
a sketch identifier for examining a manual sketch of objects to identify sketched versions of the objects, the sketch being representative of a graphic user interface (GUI) to be created; a sketch normalizer for conforming the identified sketched versions to resemble respective reference images;
a hierarchy determiner for determining, from the conformed versions, a hierarchy of relative containment among said conformed versions; and
a description generator for generating, from said hierarchy, a user interface description for creating the GUI.

2. The apparatus of claim 1, wherein said reference images comprise vector images.

3. The apparatus of claim 1, wherein the sketch normalizer is configured for straightening lines and making lines mutually parallel.

4. The apparatus of claim 1, wherein the manual sketch includes characters, and wherein the sketch identifier is configured for applying optical character recognition (OCR).

5. The apparatus of claim 1, wherein said description generator is further configured for generating the user interface description to contain a layout of said conformed versions.

6. The apparatus of claim 1, wherein the description generator is configured to generate the user interface description into a format specific to a target platform for the GUI.

7. The apparatus of claim 1, wherein the description generator is configured for generating the description into a hierarchical, structured mark-up language.

8. The apparatus of claim 1, further comprising:
an electronic storage medium;
a hand-held pen for creating the sketch; and
a digitizer for recording into the medium the sketch in real time as the sketch is being created.

9. The apparatus of claim 8, wherein the apparatus stores in said medium a normalized sketch comprising the conformed versions, said apparatus further comprising a sketch editor for editing said normalized sketch stored in said medium, said digitizer being configured for augmenting, according to input from the pen, said normalized sketch stored in said medium.

10. The apparatus of claim 1, further comprising:
an electronic storage medium for storing said reference images; and
wherein the sketch identifier is configured for using the stored reference images in identifying said sketched versions.

11. The apparatus of claim 1, wherein the description generator is configured to generate the user interface description to reflect a stacking order based on an annotation to a sketched version of an object in said sketch, said annotation indicating a priority for the annotated object with respect to at least one other of the objects as to which of two objects has priority to overlay the other of the two in said GUI.

12. The apparatus of claim 11, said apparatus being further configured to recognize that said annotation indicates priority based on a dividing line within said sketched version of an object.

13. A user interface description generating method comprising the steps of:
manually sketching objects to create a sketch representative of a graphic user interface (GUI) to be created; and
automatically performing the functions of:
examining the sketch to identify sketched versions of the objects;
conforming the identified sketched versions to resemble respective reference images;
determining, from the conformed versions, a hierarchy of relative containment among said conformed versions; and
generating, from said hierarchy, a user interface description for creating the GUI.

14. The method of claim 13, wherein the sketching step further includes the step of sketching, as an annotation to at least one of the objects, a label of a function of the object in said GUI.

15. The method of claim 13, wherein the sketching step further includes the step of sketching, as an annotation to at least one of the sketched versions of objects, a respective designation of a stacking order of that object with respect to at least one other of the objects to indicate which of two objects has priority to overlay the other of the two in said GUI.

16. The method of claim 13, wherein at least one of the sketched versions of an object intersects another sketched version of an object, and wherein the sketching step further includes the step of sketching, as an annotation to at least one of two mutually intersecting ones of the versions, a label of a function of the respective object in said GUI.

17. The method of claim 16, wherein the hierarchy determining step relatively positions in said hierarchy respective objects of said two mutually intersecting ones based on an annotation created in the annotation sketching step.

18. The method of claim 13, wherein the sketching step further comprises the steps of:
manipulating a pen by hand to create the sketch; and
recording into the medium the sketch in real time as the sketch is being created.

19. The method of claim 13, further comprising the step of pre-storing said reference images to aid in the identification performed in the examining step.

20. A computer program product comprising a computer-readable medium in which a computer program is stored for execution by a processor to generate a user interface description, the program comprising:
a sequence of instructions for examining a manual sketch of objects to identify sketched versions of the objects, the sketch being representative of a graphic user interface (GUI) to be created;
a sequence of instructions for conforming the identified sketched versions to resemble respective reference images;
a sequence of instructions for determining, from the conformed versions, a hierarchy of relative containment among said conformed versions; and
a sequence of instructions for generating, from said hierarchy, a user interface description for creating the GUI.
